(19) United States
(12) Patent Application Publication
(10) Pub. No.: US 2025/0165495 A1
(43) Pub. Date: May 22, 2025

(54) INDEX ARRAY CONVERSION DEVICE AND INDEX ARRAY CONVERSION METHOD

(71) Applicant: NEC Corporation, Tokyo (JP)

(72) Inventor: Yoshiyuki OHNO, Tokyo (JP)

(73) Assignee: NEC Corporation, Tokyo (JP)

(21) Appl. No.: 18/905,514

(22) Filed: Oct. 3, 2024

(30) Foreign Application Priority Data
Nov. 16, 2023 (JP) 2023-194835

(51) Int. Cl. G06F 16/25; G06F 16/22

(52) U.S. Cl. CPC G06F 16/258; G06F 16/2237

(57) ABSTRACT

The index array conversion device includes a generation unit that executes, for i=1 to N, a generation process to generate partial index array information Kᵢ, where indices in a range Σₜ₌₀ⁱ⁻¹ (dₜ) to Σₜ₌ₒⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index, and a subtraction unit that executes, for i=1 to N, a subtraction process to subtract Eₜ₌₀ⁱ⁻¹(dₜ) from the indices stored in the generated partial index array information Kᵢ.

This application is based upon and claims the benefit of priority from the prior Japanese Patent Application No. 2023-194835, filed Nov. 16, 2023, the entire contents of which are incorporated herein by reference.

### BACKGROUND OF INVENTION

### Field of the Invention

This present disclosure relates to an index array conversion device, an index array conversion method, and an index array conversion program.

### Description of the Related Art

Data cleansing refers to various preprocessing tasks that cleanse various types of data in a data lake into training data. FIG. 16 is an explanatory diagram showing an example of an analysis system. The analysis system shown in FIG. 16 is used as a platform for data cleansing.

The analysis system shown in FIG. 16 includes a data lake, a data cleansing unit, a training data storage unit, a learning unit, and a model storage unit. The analysis system collects data from various departments within the company and from various sources. The data lake stores a wide variety of collected data.

The data cleansing unit cleanses the data stored in the data lake into training data. In addition to simple preprocessing, the data cleansing unit may cleanse the data according to complex algorithms utilizing Artificial Intelligence (AI) or machine learning.

The data cleansing unit stores the cleansed training data in the training data storage unit. Next, the learning unit learns a model using the training data stored in the training data storage unit. The learning unit stores the learned model in the model storage unit. The analysis system utilizes the model stored in the model storage unit.

As the scale of the data to be handled increases, data cleansing tends to become a bottleneck in data analysis. For example, the time required for data cleansing may account for 80% of the total time required for data analysis. Therefore, there is a demand for speeding up data cleansing.

Among the processes targeted for speeding up in data cleansing is the process of extracting only data of rows specified by an index from the target sequence information (hereinafter simply referred to as the “target array”). FIG. 17 is an explanatory diagram showing an example of a process of extracting only the data of rows specified by an index.

As shown on the left side of FIG. 17, this process uses target array information and index array information (hereinafter simply referred to as the “index array”). The target array, labeled “value” at the top, stores data each assigned an index (0-11 on the left side of the frame). The index array, labeled “index” at the top, stores a plurality of indices.

As shown on the right side of FIG. 17, this process retrieves the data of the rows specified by the indices stored in the index array from the target array. For example, the data “8” from the row specified by the index “5” is retrieved from the target array. The array labeled “result” at the top right of FIG. 17, which stores the retrieved data in the order they were obtained, corresponds to the result of this process.

The process shown in FIG. 17 is a frequently occurring element in algorithms such as GroupBy or Sort applied to data stored in tables. Elements refer to data and indices stored in arrays. The process shown in FIG. 17 is also referred to as a take process or gather process.

FIG. 18 is an explanatory diagram showing an example of a program representing a process of extracting only the data of rows specified by an index. The process shown in FIG. 17 can be described as an element process taking two arrays, “value” and “index,” as input, as shown in FIG. 18.

According to the data structure specified by the framework applied to the process shown in FIG. 17, the target array may be stored in fragments. Fragmented data are also called chunks.

FIG. 19 is an explanatory diagram showing an example of the data structure of the target array and an example of the memory space where the target array is stored. In the data structure example shown in FIG. 19, the overall length of the target array shown in FIG. 17 is “12,” and the number of fragments is “3.” Chunks [0] to [2] represent each fragment. For example, chunk [0] represents a fragmented target array with a length of “4” stored at address 200. In the memory space shown in FIG. 19, the target array shown in FIG. 17 is stored in a distributed state across three fragments.

The reason for storing the target array in a fragmented state is explained with reference to FIG. 20 and FIG. 21. The reason for storing the target array in fragments is that it is more convenient for multiple computational threads to perform data retrieval processing in parallel.

FIG. 20 and FIG. 21 are explanatory diagrams showing other examples of the process of extracting only the data of rows specified by an index. In the processes shown in FIG. 20 and FIG. 21, threads 0 to 2 each attempt to perform data retrieval processing on their respective portions of the target array in parallel.

The rectangles shown in FIG. 20 and FIG. 21 represent the target array. The rounded rectangles enclosed by dashed lines shown in FIG. 20 and FIG. 21 represent each thread's respective portion of the target array. The shaded rectangles shown in FIG. 20 and FIG. 21 represent each thread's processing results. In the processes shown in FIG. 20 and FIG. 21, the target array is not fragmented.

In the process shown in FIG. 20, each thread directly writes its processing results to consecutive areas in the memory space. Therefore, thread 1 cannot write its processing result B to the consecutive area until thread 0 completes writing its processing result A because thread 1 does not know to what extent thread 0 will write the processing result A to the consecutive area.

Similarly, thread 2 cannot write its processing result C to the consecutive area until threads 0 and 1 complete writing their processing results. In other words, even if threads attempt to write their processing results directly to the consecutive area without copying, it is impossible to execute parallel computation because it is unclear to what extent other threads have written their results to the consecutive area.

In the process shown in FIG. 21, each thread temporarily outputs its processing results to separate areas in the memory space. That is, threads 0, 1, and 2 temporarily output their processing results A, B, and C to separate areas, respectively.

Since the results are output to separate areas, each thread can execute parallel computation. However, as shown in FIG. 21, a process is required to combine the processing results A, B, and C output to separate areas into one result. In other words, in the process shown in FIG. 21, each processing result is combined to form a continuous data structure, resulting in memory copy costs during the combination.

As described above, to execute parallel computation for the process of extracting only the data of rows specified by an index, it is often necessary to store the target array in a fragmented state to avoid inconveniences.

Furthermore, Patent Literature 1 describes a data collection processing method for collecting dispersed data in large amounts of data used in the field of information processing.
[Patent Literature 1] Japanese Patent Application Publication No. Hei 5-313912

### SUMMARY OF INVENTION

Hereinafter, issues present in the process of extracting only the data of rows specified by an index from a fragmented target array will be explained. FIG. 22 is an explanatory diagram showing an example of the process of extracting only the data of rows specified by an index from a fragmented target array.

An actual data structure shown on the left side of FIG. 22 is similar to the data structure example shown in FIG. 19. For convenience, a fragmented target array is illustrated within the actual data structure on the left side of FIG. 22.

As shown on the left side of FIG. 22, when the target array is fragmented, it is necessary to verify for each fragment which fragmented target array contains the data of the rows specified by each index.

To eliminate the need for the above verification process, the right side of FIG. 22 shows the fragmented target array combined into a single target array. Despite the target array being fragmented to avoid memory copy processing, memory copy processing is ultimately required, resulting in an unresolved cost issue.

Furthermore, Patent Literature 1 does not describe a method to solve the above issues.

Therefore, the purpose of the present disclosure is to provide an index array conversion device, an index array conversion method, and an index array conversion program that can extract only the data of rows specified by an index from a fragmented target array.

A preferred aspect of the index array conversion device includes a generation unit that executes, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index, and a subtraction unit that executes, for i=1 to N, a subtraction process to subtract Σₜ₌₀ⁱ⁻¹(dₜ) from the indices stored in the generated partial index array information Kᵢ.

A preferred aspect of the index array conversion method includes executing, for i=1 to N, a generation process to generate partial index array information Kᵢ, where indices in a range Σₜ₌₀ⁱ⁻¹ (dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index, and executing, for i=1 to N, a subtraction process to subtract Σₜ₌₀ⁱ⁻¹ (dₜ) from the indices stored in the generated partial index array information Kᵢ.

A preferred aspect of the index array conversion program causes a computer execute executing, for i=1 to N, a generation process to generate partial index array information Kᵢ, where indices in a range Σₜ₌₀ⁱ⁻¹(dₜ) to Σₜ₌₀ⁱ (dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index, and executing, for i=1 to N, a subtraction process to subtract Σₜ₌₀ⁱ⁻¹ (dₜ) from the indices stored in the generated partial index array information Kᵢ.

According to the present disclosure, it is possible to extract only the data of rows specified by the index from the fragmented target array.

### BRIEF DESCRIPTION OF THE DRAWINGS

FIG. 1 It depicts a block diagram showing an example of a configuration of a data extraction device according to the present disclosure.

FIG. 2 It depicts an explanatory diagram showing an example of dividing an index array by a global index alignment partial division unit 110.

FIG. 3 It depicts an explanatory diagram showing an example of an offset generated by the global index local block division unit 120.

FIG. 4 It depicts an explanatory diagram showing an example of a generation of a block constituting the local index array by the global index local block division unit 120.

FIG. 5 It depicts an explanatory diagram showing another example of a generation of a block constituting the local index array by the global index local block division unit 120.

FIG. 6 It depicts an explanatory diagram showing yet another example of a generation of a block constituting the local index array by the global index local block division unit 120.

FIG. 7 It depicts an explanatory diagram showing an example of the local index array generated by the global index local block division unit 120.

FIG. 8 It depicts an explanatory diagram showing an example of a conversion of a global index to a local index by a local index conversion unit 130.

FIG. 9 It depicts an explanatory diagram showing an example of data extraction by a local array extraction unit 140.

FIG. 10 It depicts an explanatory diagram showing another example of data extraction by the local array extraction unit 140.

FIG. 11 It depicts an explanatory diagram showing an example of a data structure of a local array and a memory space in which the local array is stored.

FIG. 12 It depicts a flowchart showing an operation of a data extraction process by a data extraction device 100 according to the present disclosure.

FIG. 13 It depicts a flowchart showing an operation of an index array division process by the global index alignment partial division unit 110 according to the present disclosure.

FIG. 14 It depicts an explanatory diagram showing an example of a hardware configuration of the data extraction device 100 according to the present disclosure.

FIG. 15 It depicts a block diagram showing an overview of an index array conversion device according to the present disclosure.

FIG. 16 It depicts an explanatory diagram showing an example of an analysis system.

FIG. 17 It depicts an explanatory diagram showing an example of a process of extracting only data of rows specified by an index.

FIG. 18 It depicts an explanatory diagram showing an example of a program representing the process of extracting only the data of the rows specified by the index.

FIG. 19 It depicts an explanatory diagram showing an example of a data structure of a target array and a memory space in which a target array is stored.

FIG. 20 It depicts an explanatory diagram showing another example of the process of extracting only the data of the rows specified by the index.

FIG. 21 It depicts an explanatory diagram showing another example of the process of extracting only the data of the rows specified by the index.

FIG. 22 It depicts an explanatory diagram showing an example of the process of extracting only the data of the rows specified by the index from a fragmented target array.

### DESCRIPTION OF THE PREFERRED EMBODIMENTS

### Description of the Configuration

Hereinafter, an example embodiment of the present disclosure will be explained with reference to the drawings. It should be noted that the drawings are associated with one or more example embodiments in this disclosure.

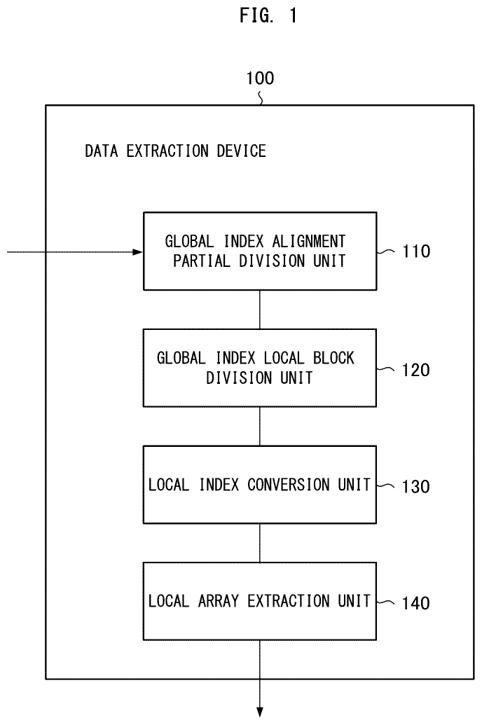

FIG. 1 is a block diagram showing an example of a configuration a data extraction device according to the present disclosure. As shown in FIG. 1, the data extraction device 100 of this example embodiment includes a global index alignment partial division unit 110, a global index local block division unit 120, a local index conversion unit 130, and a local array extraction unit 140.

The global index alignment partial division unit 110 receives the aforementioned index array as input. In this example embodiment, an index stored in the index array is referred to as a global index.

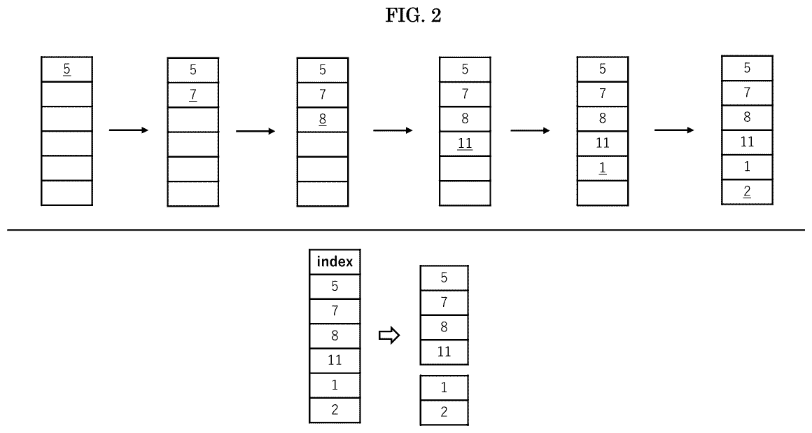

The global index alignment partial division unit 110 has a function of dividing the index array into portions where the global index is aligned. FIG. 2 is an explanatory diagram showing an example of dividing an index array by the global index alignment partial division unit 110.

As shown in FIG. 2, the global index alignment partial division unit 110 divides the index array into portions where the global indices are aligned in ascending order.

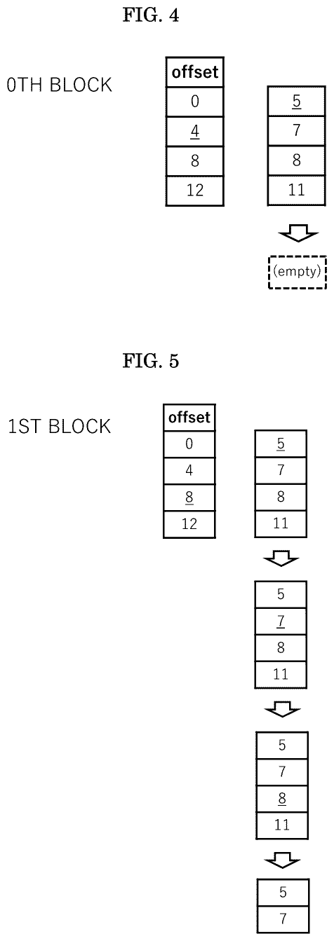

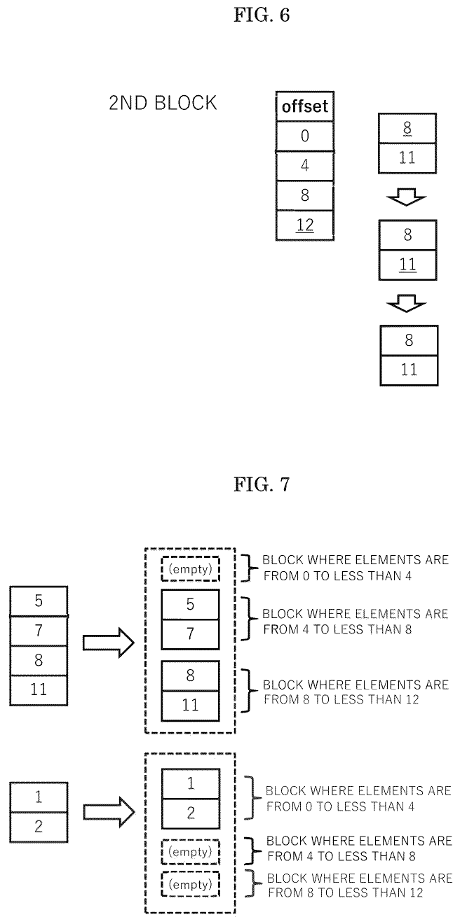

For example, as shown at the top of FIG. 2, the global index alignment partial division unit 110 checks the 0th element “5” of the index array. The underlined numbers at the top of FIG. 2 indicate an element being checked (this is also the case in FIG. 4, FIG. 5, and FIG. 6).

Since there is no element before the 0th element, the global index alignment partial division unit 110 then checks the 1st element “7” of the index array.

The 1st element “7” is greater than the previous element “5”. Therefore, the global index alignment partial division unit 110 then checks the 2nd element “8” of the index array.

The 2nd element “8” is greater than the previous element “7”. Therefore, the global index alignment partial division unit 110 then checks the 3rd element “11” of the index array.

The 3rd element “11” is greater than the previous element “8”. Therefore, the global index alignment partial division unit 110 then checks the 4th element “1” of the index array.

The 4th element “1” is smaller than the previous element “11”. Therefore, the global index alignment partial division unit 110 sets the 4th element “1” as the first element of the second aligned portion.

Next, the global index alignment partial division unit 110 checks the 5th element “2” of the index array. The 5th element “2” is greater than the previous element “1”.

Since there are no elements stored beyond the 5th element in the index array, the global index alignment partial division unit 110 divides the index array before the 4th element set as the first element of the second aligned portion.

As shown at the bottom of FIG. 2, the global index alignment partial division unit 110 divides the index array into two aligned portions. The global index alignment partial division unit 110 inputs the two aligned portions to the global index local block division unit 120.

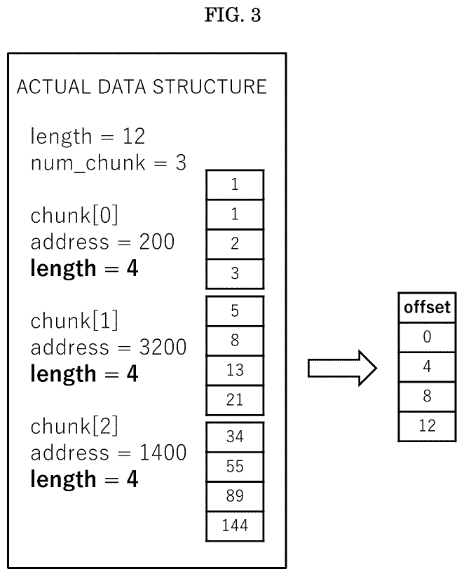

The global index local block division unit 120 has a function of dividing global indices aligned in ascending order according to the shape of a fragmented target array. FIG. 3 is an explanatory diagram showing an example of offsets generated by the global index local block division unit 120. As shown in FIG. 3, the 0th offset is “0”.

The global index local block division unit 120 calculates each offset by sequentially adding the lengths of the fragmented target arrays defined in an actual data structure. For example, the global index local block division unit 120 calculates the 1st offset “4” by adding the length “4” of the fragmented target array of chunk [0] to the 0th offset.

Next, the global index local block division unit 120 calculates the 2nd offset “8” by adding the length “4” of the fragmented target array of chunk [1] to the calculated 1st offset “4”.

Next, the global index local block division unit 120 calculates the 3rd offset “12” by adding the length “4” of the fragmented target array of chunk [2] to the calculated 2nd offset “8”.

That is, for the fragmented target arrays D₁, D₂, . . . , D_{N}, each indicating lengths d₁, d₂, . . . , d_{N} (where d₁ to d_{N} are integers of 1 or more), the global index local block division unit 120 calculates the offsets for i=1 to N (N is an integer of 2 or more) as Σₜ₌₀ⁱ(dₜ). Note that d₀=0.

In the example shown in FIG. 3, N=3.

Using the generated offsets, the global index local block division unit 120 generates a local index array composed of three blocks for each aligned portion. FIG. 4 is an explanatory diagram showing an example where the global index local block division unit 120 generates blocks constituting the local index array.

FIG. 4 shows an example where the global index local block division unit 120 generates the 0th block constituting the local index array for the first aligned portion. As shown in FIG. 4, the global index local block division unit 120 compares the 1st offset “4” with the 0th element “5”.

Since the 0th element “5” is not less than the 1st offset “4”, the global index local block division unit 120 determines that there are no elements to be stored in the 0th block. Therefore, as shown in FIG. 4, the global index local block division unit 120 generates an empty 0th block.

FIG. 5 is an explanatory diagram showing another example where the global index local block division unit 120 generates a block constituting the local index array. FIG. 5 shows an example where the global index local block division unit 120 generates the 1st block constituting the local index array for the first aligned portion.

As shown in FIG. 5, the global index local block division unit 120 compares the 2nd offset “8” with the 0th element “5”. Since the 0th element “5” is less than the 2nd offset “8”, the global index local block division unit 120 then compares the 2nd offset “8” with the next 1st element “7”.

Since the 1st element “7” is less than the 2nd offset “8”, the global index local block division unit 120 then compares the 2nd offset “8” with the next 2nd element “8”.

Since the 2nd element “8” is not less than the 2nd offset “8”, the global index local block division unit 120 determines that the elements to be stored in the 1st block are “5” and “7”.

Therefore, as shown in FIG. 5, the global index local block division unit 120 generates the 1st block storing the elements “5” and “7”.

FIG. 6 is an explanatory diagram showing another example where the global index local block division unit 120 generates a block constituting the local index array. FIG. 6 shows an example where the global index local block division unit 120 generates the 2nd block constituting the local index array for the first aligned portion.

As shown in FIG. 6, the global index local block division unit 120 compares the 3rd offset “12” with the 2nd element “8”. Since the 2nd element “8” is less than the 3rd offset “12”, the global index local block division unit 120 then compares the 3rd offset “12” with the next 3rd element “11”.

Since the 3rd element “11” is less than the 3rd offset “12”, the global index local block division unit 120 ends the block generation process because there are no elements stored beyond the 3rd element in the first aligned portion.

Therefore, as shown in FIG. 6, the global index local block division unit 120 generates the 2nd block storing the elements “8” and “11”.

Similarly, the global index local block division unit 120 generates the 0th block to the 2nd block constituting the local index array for the second aligned portion.

FIG. 7 is an explanatory diagram showing an example of the local index array generated by the global index local block division unit 120. Two local index arrays shown on the right side of FIG. 7 are the arrays generated by the global index local block division unit 120.

As shown in FIG. 7, the 0th block is a block where the stored elements are from 0 to less than 4. The 1st block is a block where the stored elements are from 4 to less than 8. The 2nd block is a block where the stored elements are from 8 to less than 12.

At the stage shown in FIG. 7, the elements stored in the local index array are global indices. That is, considering the 0th block as the first block, the ith block corresponds to partial index array information Kᵢ where the global indices in the range Σₜ₌₀ⁱ⁻¹(dₜ) to Σₜ₌₀ⁱ(dₜ)(d₀=0) are stored in ascending order.

The global index local block division unit 120 inputs the two generated local index arrays to the local index conversion unit 130.

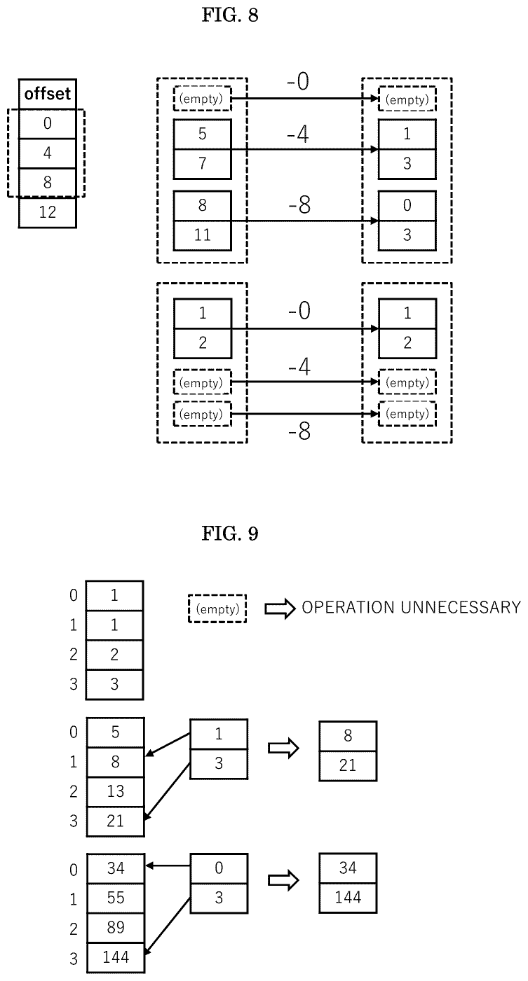

The local index conversion unit 130 has a function of converting the global indices into local indices starting from the beginning of the block for each block constituting the local index array. FIG. 8 is an explanatory diagram showing an example where the local index conversion unit 130 converts a global index into a local index.

As shown in FIG. 8, the local index conversion unit 130 subtracts the offset values of each block from the global indices. Specifically, the local index conversion unit 130 subtracts the 0th, 1st, and 2nd offsets (0, 4, 8) from the global indices stored in the 0th, 1st, and 2nd blocks, respectively.

For example, as shown in FIG. 8, the local index conversion unit 130 converts the global indices “5” and “7” stored in the 1st block constituting the first local index array into local indices “1” and “3” by subtracting the offset “4”. The local index conversion unit 130 does not perform any processing on empty blocks.

That is, considering the 0th block as the first block, the conversion process by the local index conversion unit 130 corresponds to subtracting Σₜ₌₀ⁱ⁻¹ (dₜ) from the global indices stored in the ith block.

The local index conversion unit 130 inputs the two local index arrays, in which the global indices have been converted into local indices, to the local array extraction unit 140.

The local array extraction unit 140 has a function of extracting data using a fragmented target array and a block constituting the local index array. FIG. 9 is an explanatory diagram showing an example where the local array extraction unit 140 extracts data.

The example shown in FIG. 9 is an example where the local array extraction unit 140 extracts data using a first local index array. As shown in FIG. 9, the local array extraction unit 140 extracts data by pairing the fragmented target array of chunk [0] and the 0th block constituting the local index array. Since there are no elements stored in the 0th block, the local array extraction unit 140 does not perform any data extraction operation.

Also, as shown in FIG. 9, the local array extraction unit 140 extracts data by pairing the fragmented target array of chunk [1] and the 1st block constituting the local index array. The local array extraction unit 140 extracts the data “8” and “21”. Next, the local array extraction unit 140 stores the local array Rₐ, which contains the extracted data “8” and “21,” in memory.

Also, as shown in FIG. 9, the local array extraction unit 140 extracts data by pairing the fragmented target array of chunk [2] and the 2nd block constituting the local index array. The local array extraction unit 140 extracts the data “34” and “144”. Next, the local array extraction unit 140 stores the local array R_{b}, which contains the extracted data “34” and “144,” in memory.

FIG. 10 is an explanatory diagram showing another example where the local array extraction unit 140 extracts data. The example shown in FIG. 10 is an example where the local array extraction unit 140 extracts data using the second local index array.

As shown in FIG. 10, the local array extraction unit 140 extracts data by pairing the fragmented target array of chunk [0] and the 0th block constituting the local index array. The local array extraction unit 140 extracts the data “1” and “2”. Next, the local array extraction unit 140 stores the local array R_{c}, which contains the extracted data “1” and “2,” in memory.

Also, as shown in FIG. 10, the local array extraction unit 140 extracts data by pairing the fragmented target array of chunk [1] and the 1st block constituting the local index array. Additionally, the local array extraction unit 140 extracts data by pairing the fragmented target array of chunk [2] and the 2nd block constituting the local index array. Since there are no elements stored in the 1st and 2nd blocks, the local array extraction unit 140 does not perform any data extraction operation.

That is, the local array extraction unit 140 extracts data as a local array Rᵢ from the fragmented target arrays Dᵢ, which stores one or more pieces of data each assigned a new index, using the partial index array information Kᵢ, from which the offset has been subtracted for each element. The local array extraction unit 140 executes the extraction process for local arrays Rᵢ over i=1 to N.

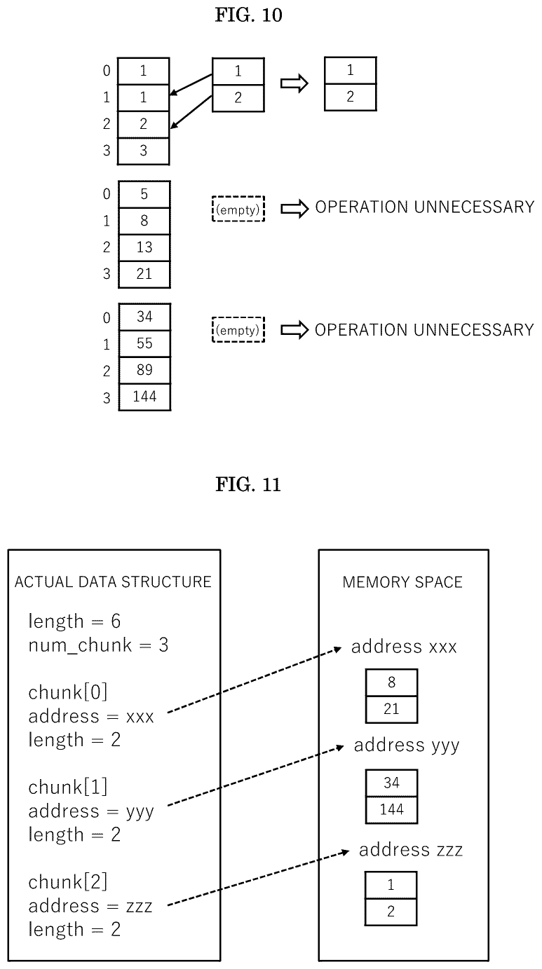

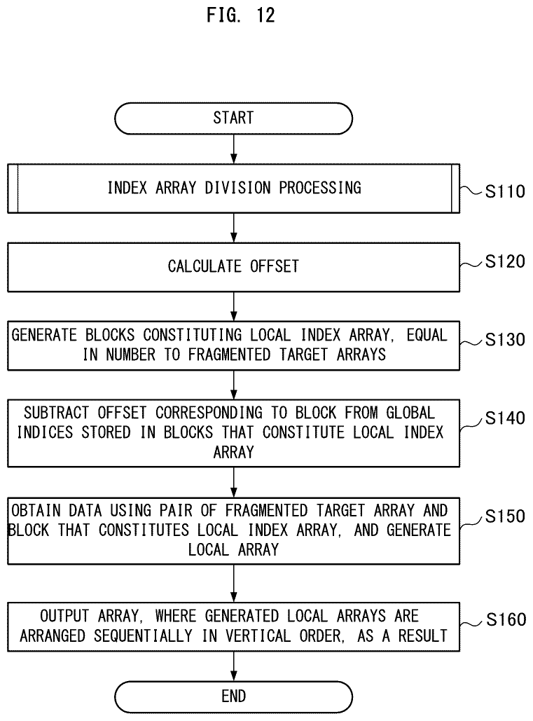

FIG. 11 is an explanatory diagram showing an example of a data structure of a local array and a memory space where the local array is stored.

In the actual data structure shown in FIG. 11, the total length of the local array is defined as “6”, and the number of fragments is defined as “3”. Chunks [0] to [2] represent each fragment. For example, chunk [0] represents the local array Rₐ with a length of “2” stored at address=xxx. The memory space shown in FIG. 11 stores the three local arrays.

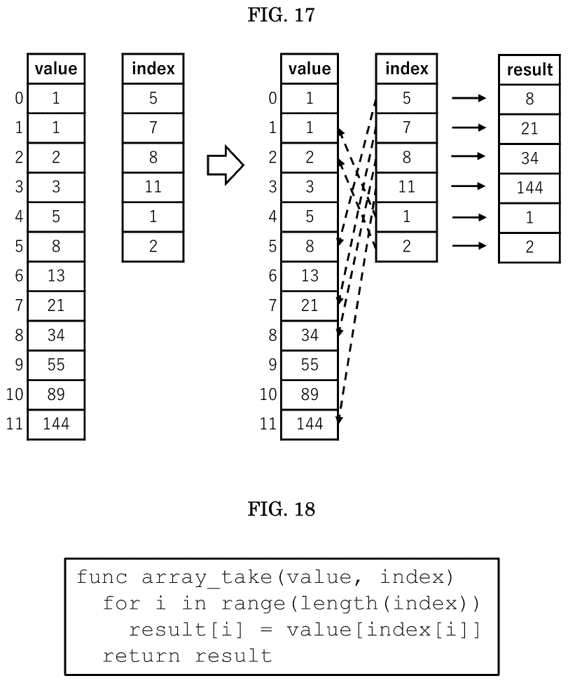

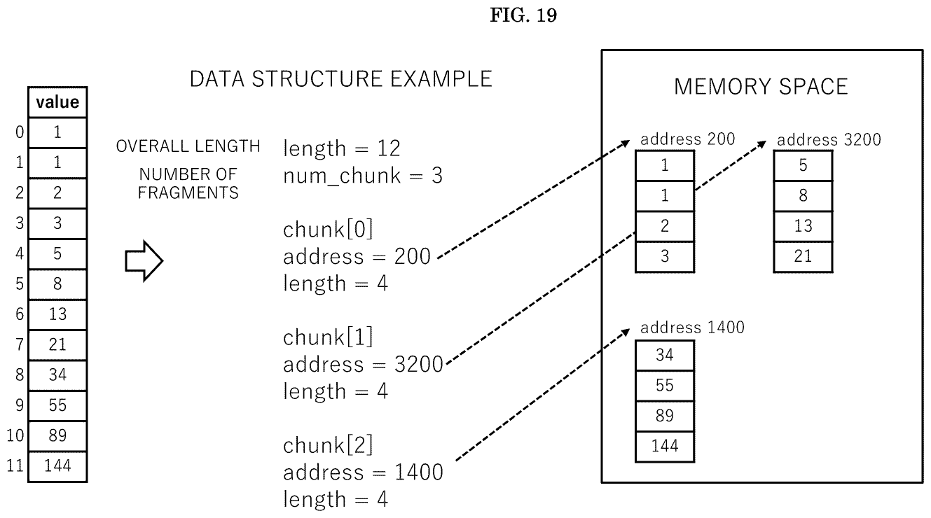

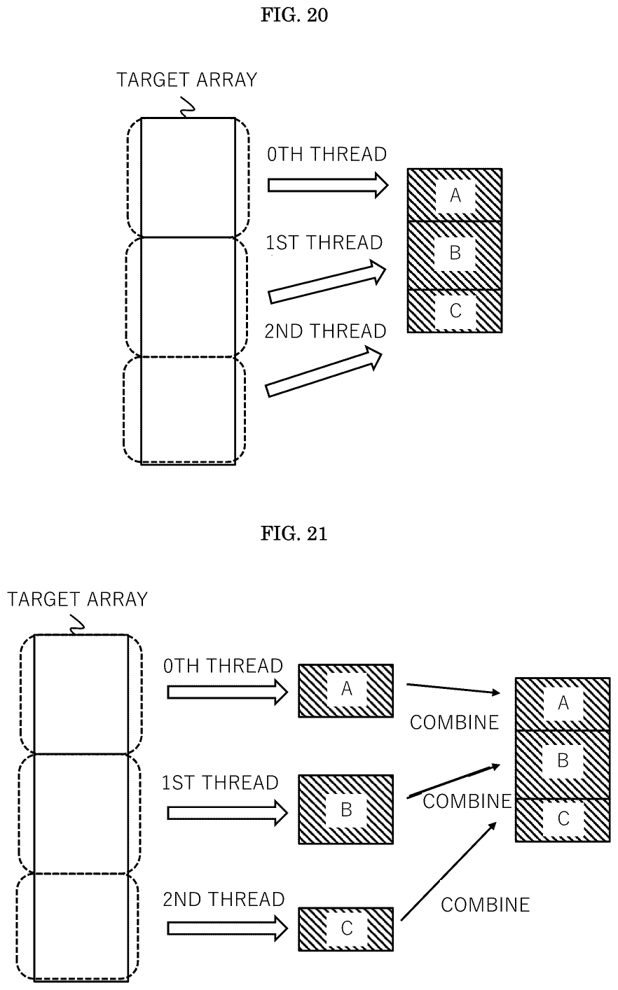

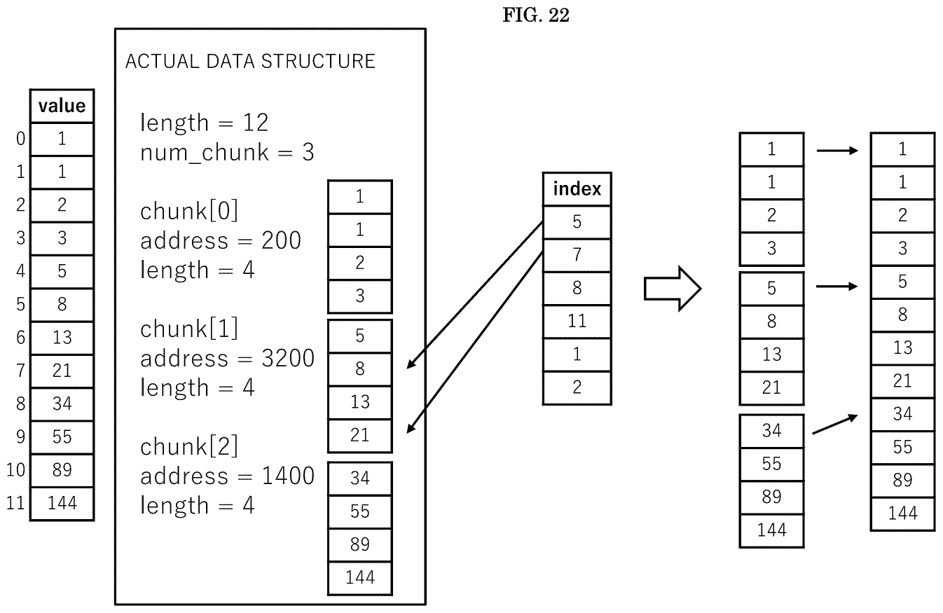

Next, the local array extraction unit 140 outputs an array, where three local arrays stored in memory are sequentially arranged vertically (an array labeled “result” shown in FIG. 17), as a result.

In the example shown in FIG. 11, the local array extraction unit 140 outputs the fragmented arrays, the local arrays Rₐ, R_{b}, R_{c}, in the order of chunk [0], chunk [1], and chunk [2]. That is, the local array extraction unit 140 outputs the data arranged vertically in the order of local arrays R₁, R₂, . . . , R_{N}.

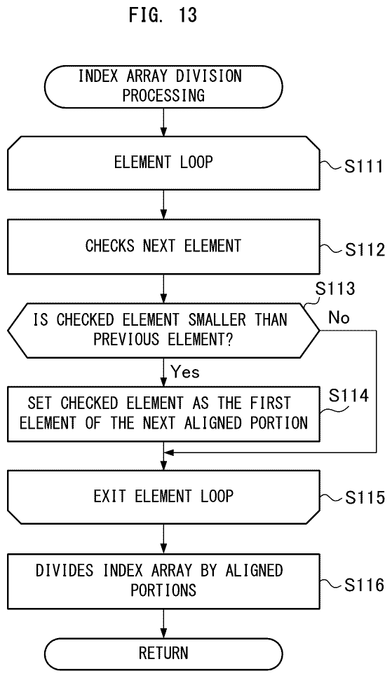

Hereinafter, an operation of the data extraction device 100 in this example embodiment will be explained with reference to FIG. 12 and FIG. 13. FIG. 12 is a flowchart showing an operation of a data extraction processing by the data extraction device 100 according to the present disclosure.

First, an index array is input to the global index alignment partial division unit 110. The global index alignment partial division unit 110 executes the index array division processing (Step S110).

Next, the global index local block division unit 120 calculates an offset by referring to a fragmented target array (Step S120).

Then, the global index local block division unit 120 generates blocks constituting a local index array, equal in number to the fragmented target arrays, using the calculated offset (Step S130). The global index local block division unit 120 inputs the local index array constituted by the generated blocks to the local index conversion unit 130.

Next, the local index conversion unit 130 subtracts the offset corresponding to the block from the global indices stored in the blocks that constitute the local index array (Step S140). The local index conversion unit 130 inputs the local index array, in which the global indices have been converted to local indices, to the local array extraction unit 140.

Then, the local array extraction unit 140 obtains data using a pair of the fragmented target array and the block that constitutes the local index array. The local array extraction unit 140 generates a local array that store the obtained data (Step S150).

Next, the local array extraction unit 140 outputs the array, where the generated local arrays are arranged sequentially in a vertical order, as a result (Step S160). After outputting, the data extraction device 100 completes the data extraction processing.

Next, the index array division processing of Step S110, which is a sub-process constituting the data extraction processing shown in FIG. 12, will be explained with reference to FIG. 13. FIG. 13 is a flowchart showing an operation of an index array division processing by the global index alignment partial division unit 110 according to the present disclosure.

First, the global index alignment partial division unit 110 enters an element loop (Step S111). Then, the global index alignment partial division unit 110 checks a next element stored in an index array (Step S112).

In the first element loop, the global index alignment partial division unit 110 checks the 0th element stored in the index array at Step S112.

Next, the global index alignment partial division unit 110 determines whether the checked element is smaller than the previous element (Step S113). If the checked element is larger than the previous element (No in Step S113), the global index alignment partial division unit 110 proceeds to Step S115.

If the checked element is smaller than the previous element (Yes in Step S113), the global index alignment partial division unit 110 sets the checked element as the first element of the next aligned portion (Step S114). After setting, the global index alignment partial division unit 110 proceeds to Step S115.

Since there is no previous element in the first element loop, the global index alignment partial division unit 110 determines that the checked element is larger than the previous element (No in Step S113).

The global index alignment partial division unit 110 repeats the processes of Steps S112 to S114 as long as there are unchecked elements stored in the index array. When all elements have been checked, the global index alignment partial division unit 110 exits the element loop (Step S115).

Next, the global index alignment partial division unit 110 divides the index array by aligned portions (Step S116). The global index alignment partial division unit 110 inputs the aligned portions generated by dividing the index array to the global index local block division unit 120. After inputting, the global index alignment partial division unit 110 returns to the data extraction processing shown in FIG. 12.

As described above, the global index local block division unit 120 in this example embodiment executes the generation process for i=1 to N, to generate partial index array information Kᵢ, where indices in the range Σₜ₌₀ⁱ⁻¹(dₜ) to Σₜ₌₀ⁱ(dₜ)(d₀=0) are stored in ascending order, using index array information (aligned portions) where a plurality of indices are stored in ascending order and partial target array information (fragmented target arrays) D₁, D₂, . . . , D_{N}, each indicating lengths d₁, d₂, . . . , d_{N} (where d₁ to d_{N} are integers of 1 or more), generated by dividing target array information into N parts (N is an integer of 2 or more), containing data each assigned the index.

Moreover, the local index conversion unit 130 in this example embodiment executes the subtraction process for i=1 to N, to subtract Σₜ₌₀ⁱ⁻¹(dₜ) from the indices stored in the generated partial index array information Kᵢ.

Furthermore, the local array extraction unit 140 in this example embodiment extracts data as an extraction result (local arrays) Rᵢ from the partial target array information Dᵢ, in which one or more pieces of data each assigned a new index are stored, using the partial index array information Kᵢ where the subtraction process has been executed. The local array extraction unit 140 executes the extraction process to extract the extraction result Rᵢ for i=1 to N, and outputs data arranged vertically in R₁, R₂, . . . , R_{N} order.

Additionally, the global index alignment partial division unit 110 in this example embodiment generates a plurality of index array information by dividing the index information (index array) composed of a plurality of index array information.

The partial target array information D₁ to D_{N} in this example embodiment may be stored in a distributed state in memory.

### Description of the Effect

The global index alignment partial division unit 110 and the global index local block division unit 120 in this example embodiment divide the index array according to the shape of the fragmented target arrays and generate the local index arrays.

Moreover, the local index conversion unit 130 converts the global indices stored in the local index array into local indices corresponding to the newly assigned indices in the fragmented target arrays.

Assigning new indices to the fragmented target arrays means that the fragmented target arrays are referenced by zero-based local indices. Therefore, the local array extraction unit 140 can extract data without combining the fragmented target arrays.

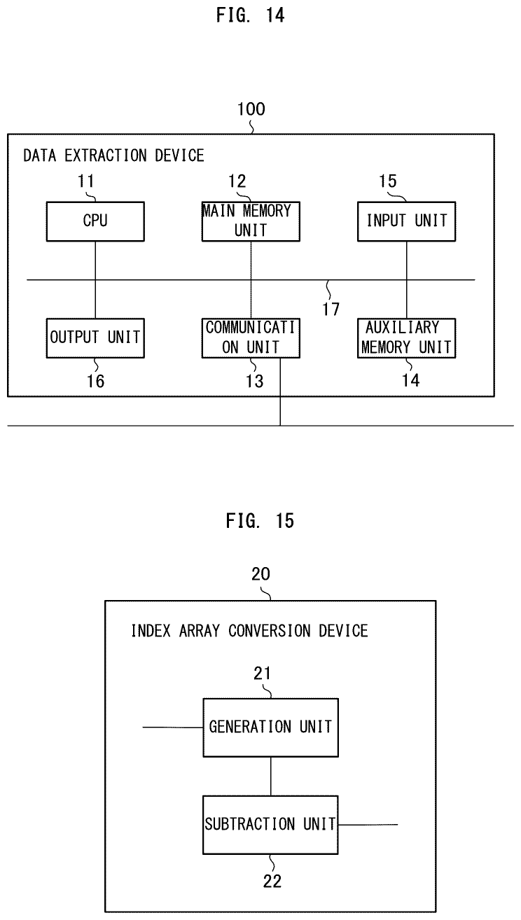

Below, a specific example of a hardware configuration of the data extraction device 100 in this example embodiment will be explained. FIG. 14 is an explanatory diagram showing an example of a hardware configuration of the data extraction device 100 according to the present disclosure.

As shown in FIG. 14, the data extraction device 100 includes a CPU (Central Processing Unit) 11, a main memory unit 12, a communication unit 13, and an auxiliary memory unit 14. It also includes an input unit 15 for user operation and an output unit 16 for presenting a processing result or progress of the processing to the user.

The data extraction device 100 is implemented in software by the CPU 11 executing programs that provide the functions of each component shown in FIG. 14.

That is, the CPU 11 loads and executes programs stored in the auxiliary memory unit 14 into the main memory unit 12, thereby controlling the operation of the data extraction device 100 and implementing each function in software.

The data extraction device 100 may include a DSP (Digital Signal Processor) instead of the CPU 11. Alternatively, the data extraction device 100 may include both the CPU 11 and the DSP.

The main memory unit 12 is used as a workspace for data and a temporary storage area for data. The main memory unit 12 may be, for example, RAM (Random Access Memory). The database 150 is implemented in the main memory unit 12.

The communication unit 13 has a function of inputting and outputting data to and from peripheral devices via a wireless network (information communication network).

The auxiliary memory unit 14 is a non-transitory tangible storage medium. Examples of non-transitory tangible storage media include magnetic disks, magneto-optical disks, CD-ROMs (Compact Disk Read Only Memory), DVD-ROMs (Digital Versatile Disk Read Only Memory), and semiconductor memory.

The input unit 15 has a function of inputting data and processing instructions. The input unit 15 may be an input device such as a keyboard, mouse, or touch panel.

The output unit 16 has a function of outputting data. The output unit 16 may be a display device such as a liquid crystal display device, a touch panel, or a printing device such as a printer.

As shown in FIG. 14, the components of the data extraction device 100 are connected to a system bus 17.

In the data extraction device 100, the auxiliary memory unit 14 stores programs to implement the global index alignment partial division unit 110, the global index local block division unit 120, the local index conversion unit 130, and the local array extraction unit 140.

The data extraction device 100 may also include hardware components such as an LSI (Large Scale Integration) that implements the functions shown in FIG. 1 internally.

Moreover, the data extraction device 100 may be implemented by hardware that does not include computer functions using elements such as a CPU. For example, a part of or all of the components may be implemented by general-purpose circuits, dedicated circuits, processors, or combinations thereof. These may be configured on a single chip (such as the aforementioned LSI) or a plurality of chips connected via a bus. A part of or all of the components may also be implemented by a combination of the aforementioned circuits and programs.

Additionally, a part of or all of the components of the data extraction device 100 may be implemented by one or more information processing devices equipped with computing and storage units.

When a part of or all of the components are implemented by multiple information processing devices or circuits, these devices or circuits may be centrally located or distributed. For example, the information processing devices or circuits may be implemented in configurations such as client-server systems or cloud computing systems, each connected via a communication network.

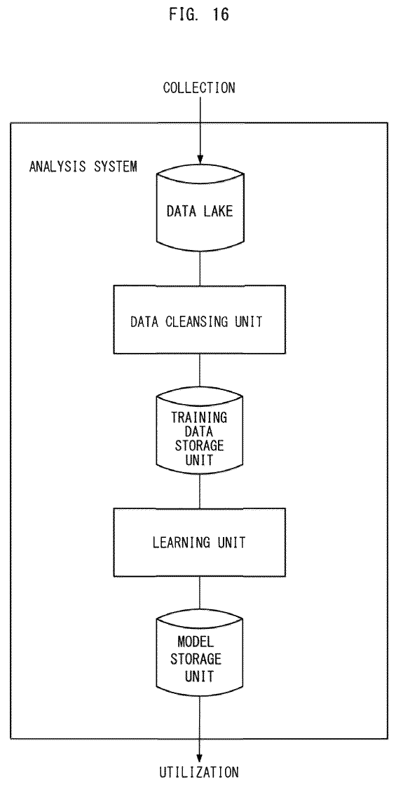

Next, an overview of the present disclosure will be explained. FIG. 15 is a block diagram showing an overview of the index array conversion device according to the present disclosure. The index array conversion device 20 according to the present disclosure includes a generation unit 21 (for example, the global index local block division unit 120) that executes, for i=1 to N, a generation process to generate partial index array information Kᵢ, where indices in a range Σₜ₌₀ⁱ⁻¹ (dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index, and a subtraction unit 22 (for example, the local index conversion unit 130) that executes, for i=1 to N, a subtraction process to subtract Σₜ₌₀ⁱ⁻¹(dₜ) from the indices stored in the generated partial index array information Kᵢ.

With such a configuration, the index array conversion device can extract only the data of rows specified by an index from a fragmented target array.

Furthermore, the index array conversion device 20 may include an extraction unit (for example, the local array extraction unit 140) that extracts data as an extraction result Rᵢ from the partial target array information Dᵢ, in which one or more pieces of data each assigned a new index are stored, using the partial index array information Kᵢ where the subtraction process has been executed.

With such a configuration, the index array conversion device can extract only the data of rows specified by an index from a fragmented target array.

The extraction unit may execute the extraction process to extract the extraction result Rᵢ for i=1 to N, and output the data arranged vertically in R₁, R₂, . . . , R_{N} order.

With such a configuration, the index array conversion device can output the data extracted from the target array before it was fragmented.

Additionally, the index array conversion device 20 may include a division unit (for example, the global index alignment partial division unit 110) that generates a plurality of index array information by dividing index information composed of a plurality of index array information.

With such a configuration, the index array conversion device can generate a plurality of index array information.

The partial target array information D₁ to D_{N} may be stored in memory in a distributed state.

Moreover, a part of or all of the components of the aforementioned example embodiments may be described as follows but are not limited to these descriptions.

(Supplementary note 1) An index array conversion device comprising:
a generation unit that executes, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d are integers of 1 or more) generated by dividing target array information into N parts (N is an integer of 2 or more), containing data each assigned the index; and
a subtraction unit that executes, for i=1 to N, a subtraction process to subtract Σₜ₌₀ⁱ⁻¹(dₜ) from the indices stored in the generated partial index array information Kᵢ.

(Supplementary note 2) The index array conversion device according to supplementary note 1, further comprising:
an extraction unit that extracts data as an extraction result Rᵢ from the partial target array information Dᵢ, in which one or more pieces of data each assigned a new index are stored, using the partial index array information Kᵢ where the subtraction process has been executed.

(Supplementary note 3) The index array conversion device according to supplementary note 2, wherein
the extraction unit executes the extraction process to extract the extraction result Rᵢ for i=1 to N, and outputs data arranged vertically in R₁, R₂, . . . , R_{N} order.

(Supplementary note 4) The index array conversion device according to any one of supplementary notes 1 to 3, further comprising:
a division unit that generates a plurality of index array information by dividing index information composed of a plurality of index array information.

(Supplementary note 5) The index array conversion device according to any one of supplementary notes 1 to 4, wherein
the partial target array information D₁ to D_{N} is stored in a distributed state in memory.

(Supplementary note 6) An index array conversion method comprising:
executing, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index; and
executing, for i=1 to N, a subtraction process to subtract Σₜ₌₀ⁱ⁻¹(dₜ) from the indices stored in the generated partial index array information Kᵢ.

(Supplementary note 7) The index array conversion method according to supplementary note 6, further comprising:
extracting data as an extraction result Rᵢ from the partial target array information Dᵢ, in which one or more pieces of data each assigned a new index are stored, using the partial index array information Kᵢ where the subtraction process has been executed.

(Supplementary note 8) The index array conversion method according to supplementary note 7, wherein
executing the extraction process to extract the extraction result Rᵢ for i=1 to N, and outputting data arranged vertically in R₁, R₂, . . . , R_{N} order.

(Supplementary note 9) The index array conversion method according to any one of supplementary notes 6 to 8, further comprising:
generating a plurality of index array information by dividing index information composed of a plurality of index array information.

(Supplementary note 10) The index array conversion method according to any one of supplementary notes 6 to 9, wherein
the partial target array information D₁ to D_{N} is stored in a distributed state in memory.

(Supplementary note 11) An index array conversion program causing a computer execute:
executing, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index; and
executing, for i=1 to N, a subtraction process to subtract Σₜ₌₀ⁱ⁻¹(dₜ) from the indices stored in the generated partial index array information Kᵢ.

(Supplementary note 12) The index array conversion program according to supplementary note 11, causing a computer execute
extracting data as an extraction result Rᵢ from the partial target array information Dᵢ, in which one or more pieces of data each assigned a new index are stored, using the partial index array information Kᵢ where the subtraction process has been executed.

(Supplementary note 13) The index array conversion program according to supplementary note 12, causing a computer execute
executing the extraction process to extract the extraction result Rᵢ for i=1 to N, and outputting data arranged vertically in R₁, R₂, . . . , R_{N} order.

(Supplementary note 14) The index array conversion program according to any one of supplementary notes 11 to 13, causing a computer execute
generating a plurality of index array information by dividing index information composed of a plurality of index array information.

(Supplementary note 15) The index array conversion program according to any one of supplementary notes 11 to 14, wherein:
the partial target array information Dᵢ to D_{N} is stored in a distributed state in memory.

As described above, the present disclosure has been explained with reference to the example embodiments, but the present disclosure is not limited to the above example embodiments. Various changes can be made to the configuration and details of the present disclosure within the scope of understanding of those skilled in the art. Each example embodiment can be appropriately combined with other example embodiments.

1. An index array conversion device comprising:
a memory storing software instructions; and
one or more processors configured to execute the software instructions to:
execute, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to du are integers of 1 or more) generated by dividing target array information into N parts (N is an integer of 2 or more), containing data each assigned the index; and
execute, for i=1 to N, a subtraction process to subtract Σₜ₌₀ⁱ⁻¹ (dₜ) from the indices stored in the generated partial index array information Kᵢ.

2. The index array conversion device according to claim 1, wherein the one or more processors are further configured to execute the software instructions to
extract data as an extraction result Rᵢ from the partial target array information Dᵢ, in which one or more pieces of data each assigned a new index are stored, using the partial index array information Kᵢ where the subtraction process has been executed.

3. The index array conversion device according to claim 2, wherein
the one or more processors execute the extraction process to extract the extraction result Rᵢ for i=1 to N, and output data arranged vertically in R₁, R₂, . . . , R_{N} order.

4. The index array conversion device according to claim 1, wherein the one or more processors are further configured to execute the software instructions to
generate a plurality of index array information by dividing index information composed of a plurality of index array information.

5. The index array conversion device according to claim 1, wherein
the partial target array information D₁ to D_{N} is stored in a distributed state in memory.

6. The index array conversion device according to claim 2, wherein
the partial target array information Dᵢ to D_{N} is stored in a distributed state in memory.

7. The index array conversion device according to claim 3, wherein
the partial target array information Dᵢ to D_{N} is stored in a distributed state in memory.

8. The index array conversion device according to claim 4, wherein
the partial target array information Dᵢ to D_{N} is stored in a distributed state in memory.

9. An index array conversion method, implemented by a processor, comprising:
executing, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index; and
executing, for i=1 to N, a subtraction process to subtract Σₜ₌₀ⁱ⁻¹(dₜ) from the indices stored in the generated partial index array information Kᵢ.

10. The index array conversion method according to claim 9, further comprising
extracting data as an extraction result Rᵢ from the partial target array information Dᵢ, in which one or more pieces of data each assigned a new index are stored, using the partial index array information Kᵢ where the subtraction process has been executed.

11. The index array conversion method according to claim 10, further comprising
executing the extraction process to extract the extraction result Rᵢ for i=1 to N, and
outputting data arranged vertically in R₁, R₂, . . . , R_{N} order.

12. The index array conversion method according to claim 9, further comprising
generating a plurality of index array information by dividing index information composed of a plurality of index array information.

13. The index array conversion method according to claim 9, wherein
the partial target array information D₁ to D_{N} is stored in a distributed state in memory.

14. A non-transitory computer readable storage medium for storing an index array conversion program for causing a computer to execute:
executing, for i=1 to N, a generation process to generate partial index array information Kᵢ, where indices in a range Σₜ₌₀ⁱ⁻¹(dₜ) to Σₜ₌₀ⁱ(dₜ)(d₀=0) are stored in ascending order, using index array information where a plurality of indices are stored in ascending order and partial target array information D₁, D₂, . . . , D_{N}, each indicating lengths d₁, d₂, . . . , d_{N} (where d₁ to d_{N} are integers of 1 or more) generated by dividing target array information into N parts (N is an integer of 2 or more), containing data each assigned the index; and
executing, for i=1 to N, a subtraction process to subtract Σₜ₌₀ⁱ⁻¹(dₜ) from the indices stored in the generated partial index array information Kᵢ.

15. The non-transitory computer readable storage medium according to claim 14, wherein
the index array conversion program causes the computer to execute:
extracting data as an extraction result Rᵢ from the partial target array information Dᵢ, in which one or more pieces of data each assigned a new index are stored, using the partial index array information Kᵢ where the subtraction process has been executed.

16. The non-transitory computer readable storage medium according to claim 15, wherein
the index array conversion program causes the computer to execute:
executing the extraction process to extract the extraction result Rᵢ for i=1 to N; and
outputting data arranged vertically in R₁, R₂, . . . , R_{N} order.

17. The non-transitory computer readable storage medium according to claim 14, wherein
the index array conversion program causes the computer to execute:
generating a plurality of index array information by dividing index information composed of a plurality of index array information.

18. The non-transitory computer readable storage medium according to claim 14, wherein
the partial target array information D₁ to D_{N} is stored in a distributed state in memory.
